(19) United States
(12) Patent Application Publication
(10) Pub. No.: US 2009/0279611 A1
(43) Pub. Date: Nov. 12, 2009

(54) Video edge filtering

(76) Inventor: John Gao, Coventry (GB)

Correspondence Address: FLYNN THIEL BOUTELL & TANIS, P.C., 2026 RAMBLING ROAD, KALAMAZOO, MI, 49008-1631, US

(21) Appl. No.: 12/387,234

(22) Filed: Apr. 29, 2009

(30) Foreign Application Priority Data
Apr. 29, 2008 (GB) 0807804.0

(51) Int. Cl. H04N 7/24

(52) U.S. Cl. 375/240.24; 375/E07.02

(57) ABSTRACT

A method and apparatus are provided for performing overlap transform and deblocking of a decompressed video signal. The video image is sub-divided into a plurality of non-overlapping macroblocks, each of which comprises a plurality of smaller sub-blocks. Each macroblocks comprises two luminance partitions and one chrominance partition. Each partition is buffered and further buffering is provided for sub-blocks of each partition. Overlap transform and deblocking are performed by buffering sub-blocks from current partitions and sub-blocks from partitions from adjacent macroblocks. Overlap transform is performed in the current macroblock for buffered sub-blocks and deblocking is performed for blocks in the adjacent macroblocks.

### FIELD OF THE INVENTION

This invention relates to an efficient Video Edge Filtering approach for use with VC-1 video compression systems based on three different 16×8 pixel partitions.

### BACKGROUND TO THE INVENTION

In recent years digital video compression and decompression have been widely used in video related devices including digital TV, mobile phones, laptop and desktop computers, netbook, PMP (personal media player), PDA and DVD. In order to compress video, a number of video coding standards have been established, including H.263 by ITU (International Telecommunications Union), MPEG-2 and MPEG-4 by MPEG (Moving Picture Expert Group). In particular the two latest video coding standards, H.264 by ITU and VC-1 by ISO/IEC (International Organization for Standardization/International Electrotechnical Commission), have been adopted as the video coding standards for the next generation of high definition DVD, and HDTV in US, Europe and Japan. As all those standards are block based compression schemes, a new edge smoothing feature, called de-blocking is introduced in the two new video compression standards. In addition VC-1 also has an in-loop overlap transform for the block edge smoothing. The purpose of these is to reduce visible blocking artefacts caused by the blocks into which pictures are divided. As VC-1 requires two different edge smoothing for the pictures, its edge filtering is the most complicated among the video compression standards.

Picture compression is carried out by splitting a picture into non-overlapping 16×16 macroblocks formed from 4×4 sub-blocks and encoding each of those 16×16 macroblocks sequentially. Because the human eye is less sensitive to chrominance than luminance, all video compression standards specify that in a colour picture the chrominance resolution is half of the luminance resolution horizontally and vertically. So each of the colour macroblocks consists of a 16×16 luminance pixel block that is called Y block, and two 8×8 chrominance pixel blocks that are called Cb and Cr blocks.

In general each of the digital video pictures is encoded by removing redundancy in the temporal and spatial directions. Spatial redundancy reduction is performed by only encoding intra picture residual (difference) data between a current macroblock and its intra predictive pixels. Intra predictive pixels are created by interpolation of the pixels from previously encoded macroblocks in the same picture. An encoded picture with all intra-coded macroblock is called an I-picture.

Temporal redundancy reduction is performed by only encoding inter residual (difference) data between a current macroblock and a corresponding inter predictive macroblock from another picture. An inter predictive macroblock is created by interpolation of pixels from reference pictures that have been previously encoded. The amount of motion between a block within a current macroblock and a corresponding block in the reference picture is called a motion vector.

Furthermore, an inter-coded picture with only forward looking reference pictures is called a P-picture, and an inter-coded picture with both forward and backward reference pictures is called a B-picture.

As shown in FIG. 1, a VC-1 encoder first obtains the best inter prediction from a reference picture by motion estimation, and compares this prediction to an intra prediction mode. Then it encodes a current macroblock as either an intra macroblock or an inter macroblock. While encoding an intra macroblock, its transform coefficient residuals are encoded into the stream of data created. While encoding an inter macroblock, its motion vectors and pixel residuals are encoded into the stream. In addition, in VC-1 individual 8×8 block in an inter macroblock may be encoded as intra block.

The system shown comprises a frame buffer 100 storing input video data. A motion estimation unit 110 performs motion estimation from a reference picture and provides motion vectors to a motion vector encoding unit 150 which encodes the motion vectors into the bitstream. Vectors are also provided to a motion compensation unit 120 which provides inter predicted pixel with motion compensation.

After intra and inter encoding costs are compared and then one of them is selected in intra/inter selection unit 140, intra pixels or inter pixel residual data is encoded into the stream by the pixel/residual encoding unit 160. The encoded pixel data also passes to a local pixel/residual decoding unit 170 to get decoded intra pixel or inter residuals. Then inter residuals is recombined with inter predicted pixels from unit 120 to provide data to an overlap transform/deblocking unit 130 which removes blocking artefacts and provides pixel data back to the frame buffer 100, where the pixels are needed as reference for following pictures.

As shown in FIG. 2, a VC-1 decoder first decodes motion vectors in unit 210 and pixel/residuals of every macroblock in unit 220, and then obtains the intra or inter predictive blocks of every macroblock. Finally, decoded intra or inter pixels is de-blocked in unit 250 to form a final decoded picture that is passed to a frame buffer 230 with a video output. VC-1 also introduces another edge filter before de-blocking, called an overlap transform, to further smooth the edges between two 8×8 intra blocks in pictures. There is a local decoding loop in an encoder to create a decoded reference picture, so that both edge filters are also used in an encoder.

While encoding each of the 16×16 macroblocks, each is further split into smaller sub-blocks (e.g. 4×4 sub-blocks) for some parts of the encoding processing. As a result the blocking artefact could occur at each one of the sub-block edges in a coded picture. In order to remove the inherent blocking artefact, an overlap transform and de-blocking steps are inserted into the processing loop. In VC-1 the smallest block size is 8×8 in the overlap transform, 4×4 in progressive picture de-blocking, and 4×2 in interlaced picture de-blocking.

Within an interlaced video source, each of the frames (pictures) consists of two interlaced fields, a top field and a bottom field. Its top field consists of all even lines within the frame and its bottom field consists of all odd lines within the frame. A macroblock in an interlaced frame is shown in FIG. 3, 300 is its 16×16 Y block that can be split to two 16×8 Y field blocks, top field 16×8 Y block 300T and bottom field 16×8 Y block 300B. 310 is its two 8×8 Cb and Cr blocks (because of the lower resolution required).

To maximize compression efficiency either frame coding mode or field coding mode can be used to encode an interlaced frame at the picture level and at the macroblock level. While frame or field coding mode is used in the picture level, an interlaced frame is encoded as either a frame coded picture or two separate field coded pictures. Within a field coded picture, all macroblocks are field-coded macroblocks as all their pixels belong to the same field. But for a frame-coded picture, each of its macroblocks could be either frame-coded or field-coded. In a frame-coded macroblock, each of its 16×8 or 8×8 Y sub-blocks is frame based so that half of its pixels belong to the top field and another half of its pixels belong to the bottom field. In contrast, in a field-coded macroblock, all pixels in each of the coded 16×8 or 8×8 Y sub-blocks belong to the same field, either a top field or a bottom field. The 8×8 Cb and Cr blocks are always treated as frame coded during the overlap transform and de-blocking.

VC-1 specifies different edge filtering requirements for the overlap transform in interlaced pictures. The overlap transform is a one-dimensional edge filter and it is applied to the edges between two 8×8 intra-coded blocks. As shown in FIG. 4, it requires 2 pixels on each side of an edge as its input. A vertical edge and a horizontal edge for the overlap transform are shown in 400 and 410 respectively. After edge filtering of the overlap transform, the values of p0, p1, q0 and q1 can be changed. Furthermore, the overlap transform needs to be performed before the de-blocking if there are any pixels to be shared by the edge filtering process of overlap transform and de-blocking.

There are different requirements of the overlap transform for different types of interlaced pictures. For field-coded I and P pictures, both horizontal and vertical edges between two adjacent 8×8 intra coded blocks require an overlap transform with vertical edge filtering first followed by horizontal edge filtering. For frame coded I and P pictures, the overlap transform is only applied to the vertical edges between two horizontally adjacent 8×8 intra coded blocks. For frame or field coded B-pictures, no overlap transform is needed. The vertical edge filtering order for the overlap transform is from the top to the bottom of the picture, and the horizontal edge filtering order of the overlap transform is from left to right of the picture.

Similarly to the overlap transform order, VC-1 specifies different de-blocking requirements for interlaced pictures. Firstly, de-blocking is one-dimensional edge filtering and requires up to 4 pixels an each side of an edge to derive its final results as shown in FIG. 5. A 1-line vertical edge and a 1-line horizontal edge for de-blocking are shown at 500 and 510 respectively. Also a 4-line vertical edge is shown at 520 where there are two horizontally adjacent 4×4 blocks in both sides of the edge.

After the de-blocking edge filtering of the VC-1, the values of p0, and q0 can be changed. De-blocking edge filtering is performed for a field so that all required pixels for edge filtering are from the same field. Also the de-blocking edge filtering order requires that the horizontal edge filtering is done before the vertical edge.

There are also different orders of de-blocking edge filtering for different types of interlaced pictures. VC-1 specifies the de-blocking edge filtering order for a picture so that all horizontal edges need to be filtered before all vertical edges in a picture. While performing either horizontal or vertical edge filtering in a field coded picture the filtering for the multiples of 8^{th} pixel interval edges has to be performed before filtering for multiples of 4^{th} pixel interval edges. For field coded I pictures, de-blocking is only performed for all of the 8×8 block edges. For field coded P and B pictures, the de-blocking can be performed for all of the 4×4 sub-block edges.

Based on the order specified in VC-1 standard, the de-blocking edge filtering order of a macroblock in a field coded picture has been derived and is shown in FIG. 6. As the picture is field coded, the whole macroblock belongs to the same field. The dark areas are from a current macroblock. 610 show the de-blocking edge order of a 16×16 Y block, 620 and 630 give the de-blocking edge order of the corresponding 8×8 Cb and Cr blocks respectively.

For a frame coded interlaced picture, the edge filtering order is similar so that the horizontal edges need to be filtered before the vertical edges. The horizontal edge filtering order is from top to bottom, and vertical edge filtering order is from left to right. For all macroblocks in frame coded I pictures and field coded macroblocks in frame coded P and B pictures, the de-blocking can be performed in each of 4×4 field block edges. For a frame coded macroblock in frame coded P and B pictures, the de-blocking can be performed for each of two 4×2 field block edges.

Based on the VC-1 de-blocking edge order in a picture, corresponding macroblock edge orders in a frame coded interlaced picture can be derived. FIG. 7 gives the de-blocking edge order of a 16×16 Y block in a frame coded macroblock. FIG. 8 gives the de-blocking edge order of 16×16 Y block in a field coded macroblock, and FIG. 9 gives the de-blocking edge order of 8×8 Cb and Cr blocks respectively. While performing overlap transform and de-blocking in parallel, a preferred method is to perform de-blocking for upper macroblocks while performing overlap transform filtering for a current macroblock. Therefore 16 upper rows of Y pixels for a field coded macroblock and 20 upper rows of Y pixels for a frame coded macroblock need to be loaded back for de-blocking while the overlap transform is performed in a current macroblock.

There are several potential problems with VC-1 edge filtering. Firstly, with the de-blocking edge order VC-1 specified the de-blocking of a macroblock cannot be done until its lower adjacent macroblock is available (where lower means spatially positioned beneath the current macroblock in an image). Therefore each upper adjacent field macroblock has to be loaded back from a frame buffer for de-blocking and then sent back to the frame buffer after de-blocking (where upper means spatially positioned above a current macroblock). As a result more than 200% of extra data bandwidth is needed for input and output of an upper field macroblock and the last 4 lines of the high adjacent macroblock for an upper field macroblock. As a frame buffer is normally located externally, such a large extra bandwidth requirement is a particular concern in high definition video compression and decompression.

Secondly, proper edge filtering orders are required to perform the edge filtering for overlap transform and de-blocking in parallel at the macroblock level as their edge filtering requirements are different for different types of macroblocks and the overlap transform has to be performed before de-blocking for any shared input pixel data. Thirdly macroblock based edge filtering requires an local input buffer for a local filter to store all related pixels from current, upper and left macroblocks for the whole macroblock.

Finally the edge filtering orders and intermediate data sharing make the edge filtering difficult to pipeline to meet the speed demand in high definition video encoding and decoding.

### SUMMARY OF THE INVENTION

Preferred embodiments of the invention provide an approach to perform efficiently overlap transform and de-blocking with a single 4-line edge filter on the basis of three 16×8 partitions of a macroblock. Each macroblock in an interlaced picture is split into three 16×8 partitions, a first 16×8 Y block, a second 16×8 Y block, and a Cb/Cr partition including 8×8 Cb and Cr blocks. For each of the three partitions, overlap transform and de-blocking are performed using 4-line edge filtering with efficient edge filtering orders that can work with each of 16×8 partitions, with a reduced data bandwidth.

With proper edge filtering orders in the different 16×8 pixel partitions, a single 4-line edge filter can be used to implement both VC-1 overlap transform and de-blocking in interlaced and progressive scanned pictures. It reduces the extra luminance bandwidth between external frame buffer and local filter by up to 50%, and reduces local buffer size by about ⅔. The approach makes the pixel data block reuse gap to be at least 4 so that the edge filtering can be performed efficiently. It can be used for high speed VC-1 video edge filtering in high definition video compression and decompression.

The approach gives several benefits. Firstly both the overlap transform and de-blocking in an interlaced picture can be performed in parallel by a single programmable 4-line edge filter. Secondly 16×8 based edge filtering reduces the extra luminance bandwidth for the load and output of upper macroblocks by up to 50% so that local buffer size for storing upper luminance rows is also reduced by up to 50%. Thirdly as only about ⅓ of the edges of a macroblock are processed each time, it reduces the complexity of edge ordering and local buffer size to about ⅓ of a macroblock based edge filter. In addition the proper edge ordering can efficiently avoid the processing stall of the edge filter.

### BRIEF DESCRIPTION OF THE DRAWINGS

FIG. 1 is a block diagram of a VC-1 video compression system which may use the invention;

FIG. 2 is a block diagram for a VC-1 video decompression system which may use the invention;

FIG. 3 shows schematically the luminance and chrominance blocks into which an interlaced video signal is divided for compression/decompression;

FIG. 4 shows one dimensional edge filtering of VC-1 overlap transform;

FIG. 5 shows schematically more dimensional edge filtering for de-blocking, include a four line vertical edge filter;

FIG. 6 shows the de-blocking edge filtering order for a macroblock in a field coded picture;

FIG. 7 shows the luminance de-blocking edge filtering order for a frame coded macroblock in a frame coded interlace picture using VC-1;

FIG. 8 shows the luminance de-blocking edge filtering order for a field coded macroblock in a frame coded interlace picture using VC-1;

FIG. 9 shows the chrominance de-blocking edge filtering order for a macroblock in a frame coded interlace picture using VC-1;

FIG. 10 is a block diagram of a 4 line edge filter that can be used for overlap transform and de-blocking embodying the invention;

FIG. 11 shows the edge filtering order for VC-1 overlap transform in luminance and chrominance blocks in a field coded picture;

FIG. 12 shows the three 16×8 partitions based de-blocking edge filtering order for luminance and chrominance in a macroblocks of a field coded picture using VC-1;

FIG. 13 shows the edge filtering order for overlap transform for three 16×8 partitions in a frame or field coded macroblock in a frame coded interlace picture using VC-1;

FIG. 14 shows the de-blocking edge filtering order for two 16×8 luminance partitions in the frame or field coded macroblock in a frame coded interlace picture using VC-1;

FIG. 15 shows the edge filtering order for de-blocking of 16×8 chrominance partitions in a frame or field coded macroblock in a frame coded interlace picture using VC-1;

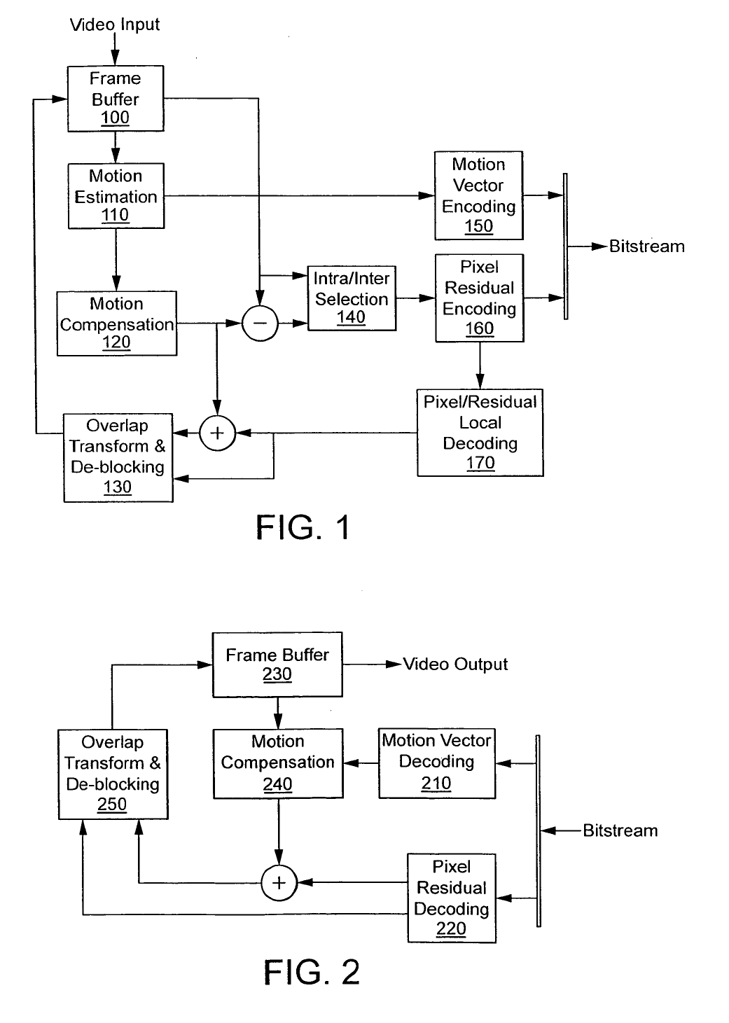

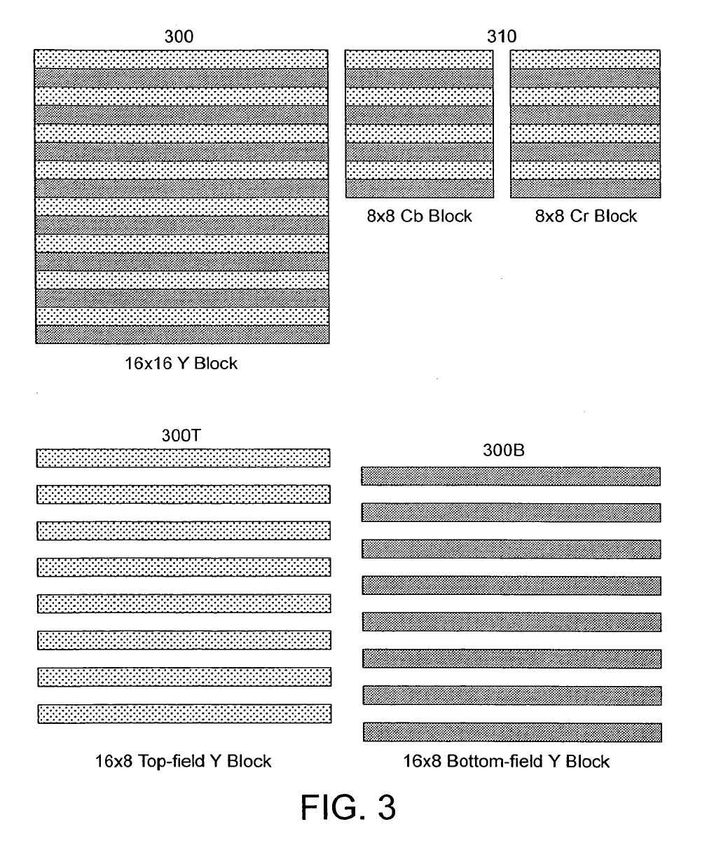

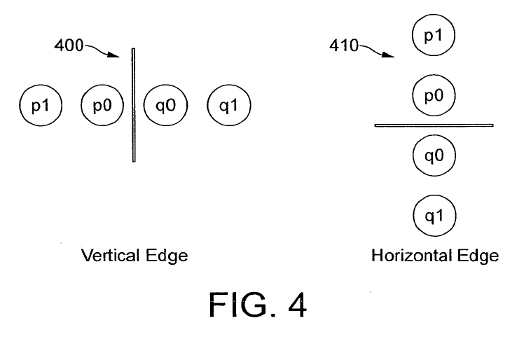

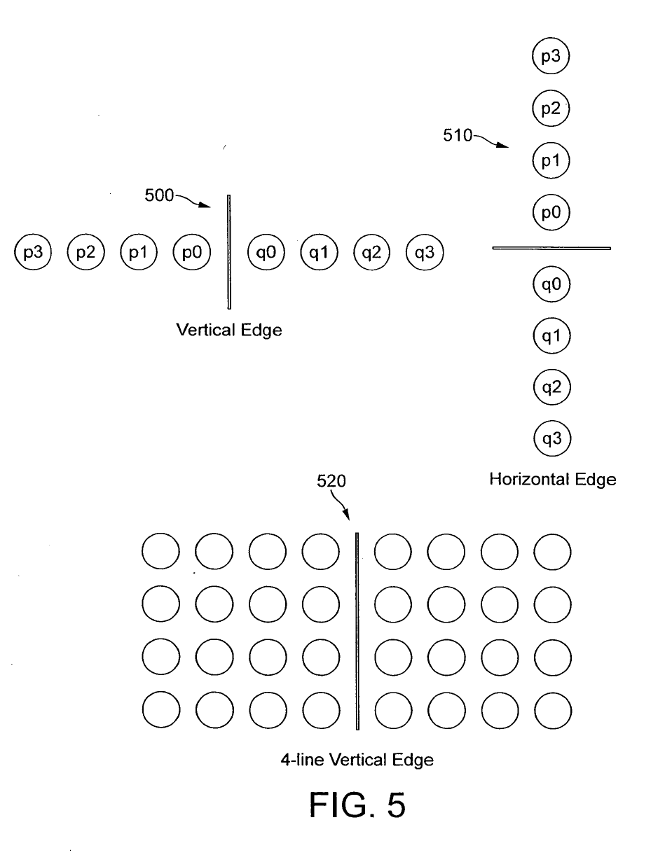

### DETAILED DESCRIPTION OF A PREFERRED EMBODIMENT

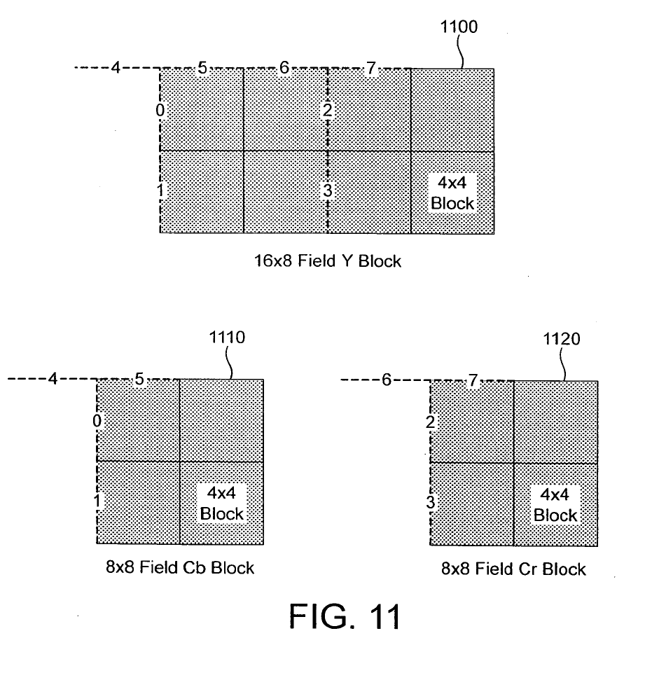

A 4-line edge filtering apparatus is shown in FIG. 10. 1000 is an external frame buffer from which the edge filter obtains the required pixels for upper macroblocks. 1010 is a local tile buffer for temporary storage of 4×4 blocks to be filtered. 1020 is a local pixel decoder which provides all pixels in a decoded current macroblock. 1030 is a 4-line vertical edge filter. and 1040 is an output buffer.

The basic filtering operation in VC-1 overlap transform and de-blocking is treated as single one-dimensional 4-line edge filtering. From each of the 4-line edges, two 4×4 blocks on each side of the edge are sent from the local buffer 1010 to the 4-line edge filter 1030. The result and data needed for subsequent filtering is sent back to the local buffer 1010. The final results are then sent to the local output buffer 1040.

Before the edge filtering of each 16×8 partition, all required 4×4 blocks from upper, left and lower left fields of a current macroblock are loaded to the local buffer 1010. After edge filtering of each 16×8 partition, the 4×4 blocks needed for the edge filtering of a following partition and next macroblock are sent back to local buffer 1010.

When reorganising the 4-line edge filtering orders for overlap transform and de-blocking, there are three factors to be considered. Firstly the overlap transform has to be performed before the de-blocking as VC-1 specified. Secondly, the order of overlap transform or de-blocking has to compatible with VC-1 specified edge orders so that they give the same final results. Finally, the ordering should make the minimum gap between reuse of the same 4×4 block as big as possible in order to minimize any possible stalling of the edge filtering pipeline that may occur if a filtered 4×4 block is needed before it is available. In our example ordering, there is a gap of at least 4 edges for a 4×4 block being reused by another edge filtering, which means there is no processing stall if the edge filter needs up to 4 cycles to process a 4-line edge.

VC-1 specifies the edge order of overlap transforms in field coded pictures such that the specified vertical 8×8 block edges are filtered before the specified horizontal 8×8 block edges. The 4-line edge filtering order for each of three 16×8 partitions in a field macroblock in an embodiment of the invention is determined as shown in FIG. 11. 1100 is the edge order for 16×8 top field and bottom field Y blocks, 1110 and 1120 are the edge orders of 8×8 Cb and Cr blocks. In the Y blocks, the left vertical edge of the leftmost blocks are filtered first and finally the topmost horizontal edges, using data from an upper adjacent block, and horizontally adjacent blocks.

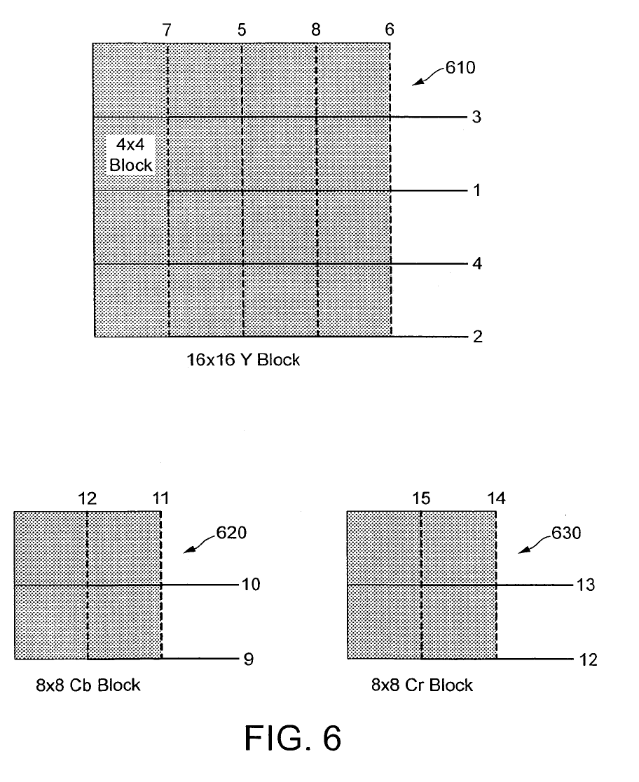

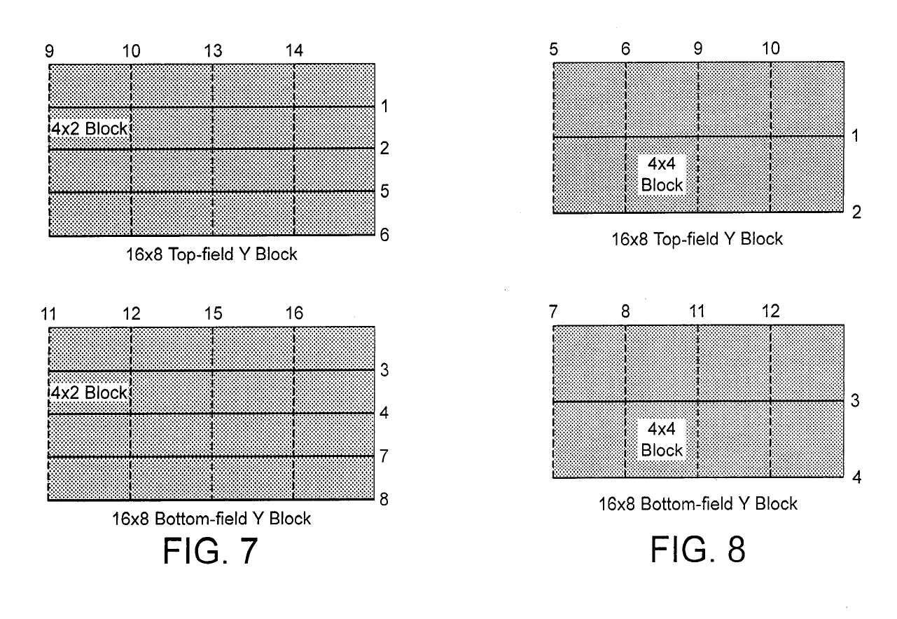

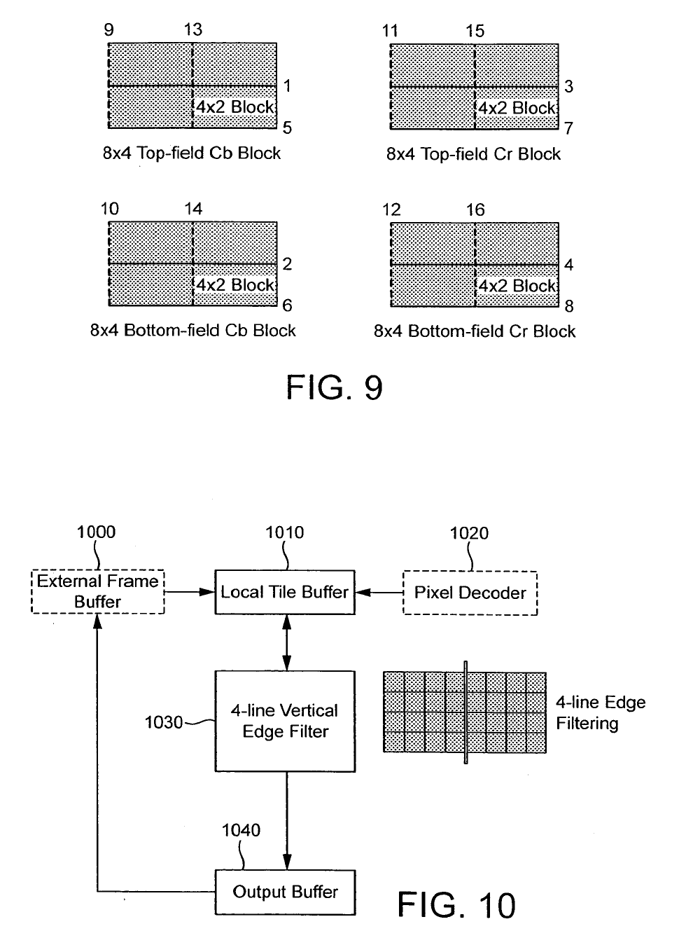

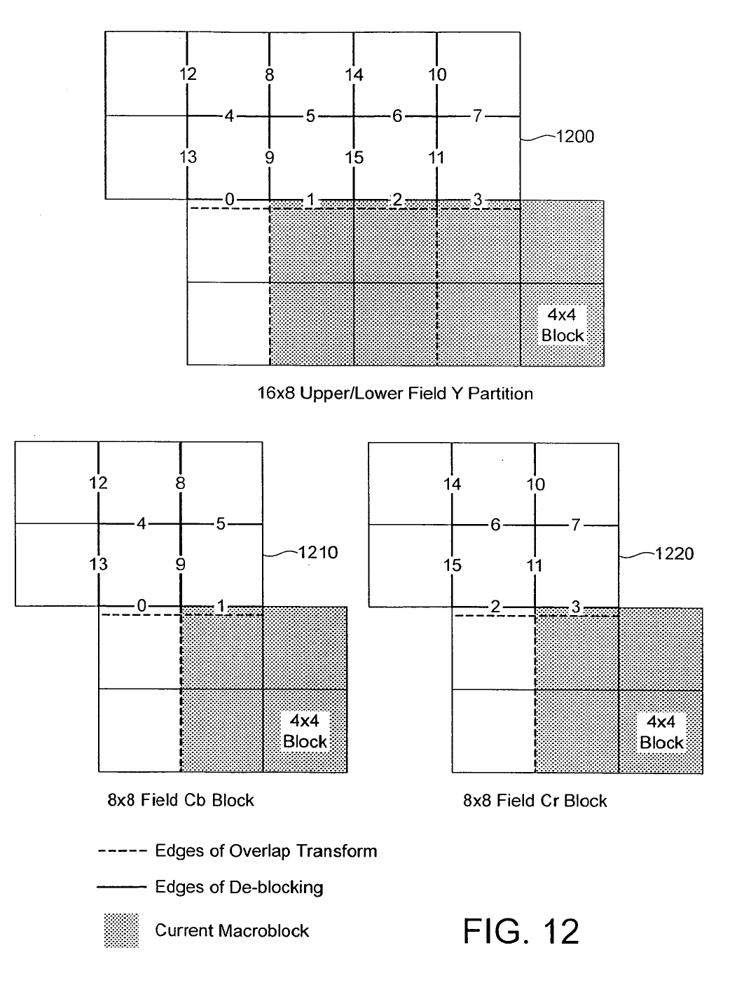

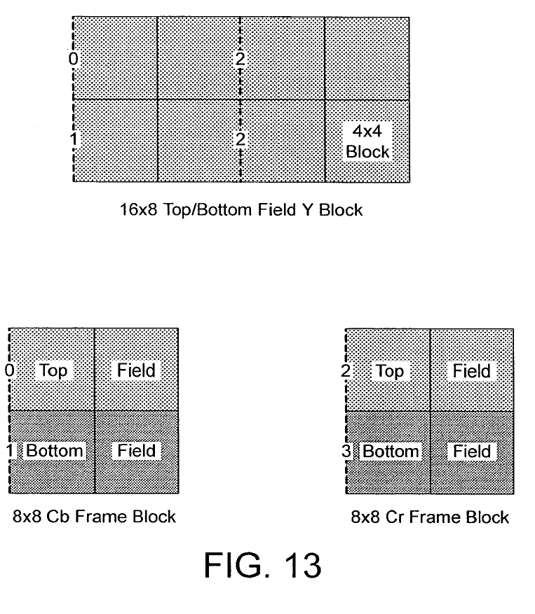

VC-1 specifies the de-blocking edge order in field coded pictures as shown in FIG. 6. The 4-line edge filtering order for each of three 16×8 partitions in a field macroblock in an embodiment of the invention is determined as shown in FIG. 12. The dark area is a current 16×8 partition. 1200 is the de-blocking edge order for each of two 16×8 Y partitions, 1210 and 1220 are the edge filtering orders of the 8×8 Cb and Cr blocks. Also the edges of the overlap transform are shown in dotted lines in FIG. 12. From the figure, 18 4×4 blocks are needed for edge filtering of a 16×8 Y partition and 20 4×4 blocks are need for edge filtering of a Cb/Cr partition. As only 8 rows of Y pixels in the upper macroblocks are needed, the Y pixel bandwidth is reduced by 50%. In order to ensure the overlap transform always is performed before the de-blocking and the edge filtering can be performed in the 16×8 partition layer, the overlap transform is performed in current 16×8 partition. The de-blocking filtering is performed on the edges in the current and adjacent upper partitions. Therefore, upper partitions for the upper 16×8 Y partition and 16×8 chroma partition are from an adjacent upper macroblock and an adjacent upper-left macroblock so they need to be loaded from external from buffer before their filtering. The order in FIG. 12 is for both upper and lower 16×8 Y partitions of a current macroblock. The only difference is for an adjacent upper 16×8 partition, its upper and upper-left adjacent partitions are from upper and upper-left adjacent macroblocks. For a lower 16×8 Y partition, its upper and upper-left adjacent partitions are from a current and adjacent left macroblocks that are not in the external buffer. Thus it can be seen that overlap transform is performed on a current macroblock, and because data is required from adjacent upper and upper left macroblocks, deblocking is performed on those adjacent upper and upper left macroblocks.

The edge orders of overlap transforms for three 16×8 partitions in a frame or field coded macroblock for a frame coded interlaced picture in an embodiment of the invention are shown in FIG. 13. VC-1 specifies that in the edge filtering of overlap transforms in a frame coded interlaced picture only the vertical edges between two 8×8 intra blocks need to be filtered. Thus for the Y fields, the leftmost edges are first filtered followed by the central edge between two 8×8 blocks. For the Cr/Cb blocks only the leftmost edges are filtered from top to bottom.

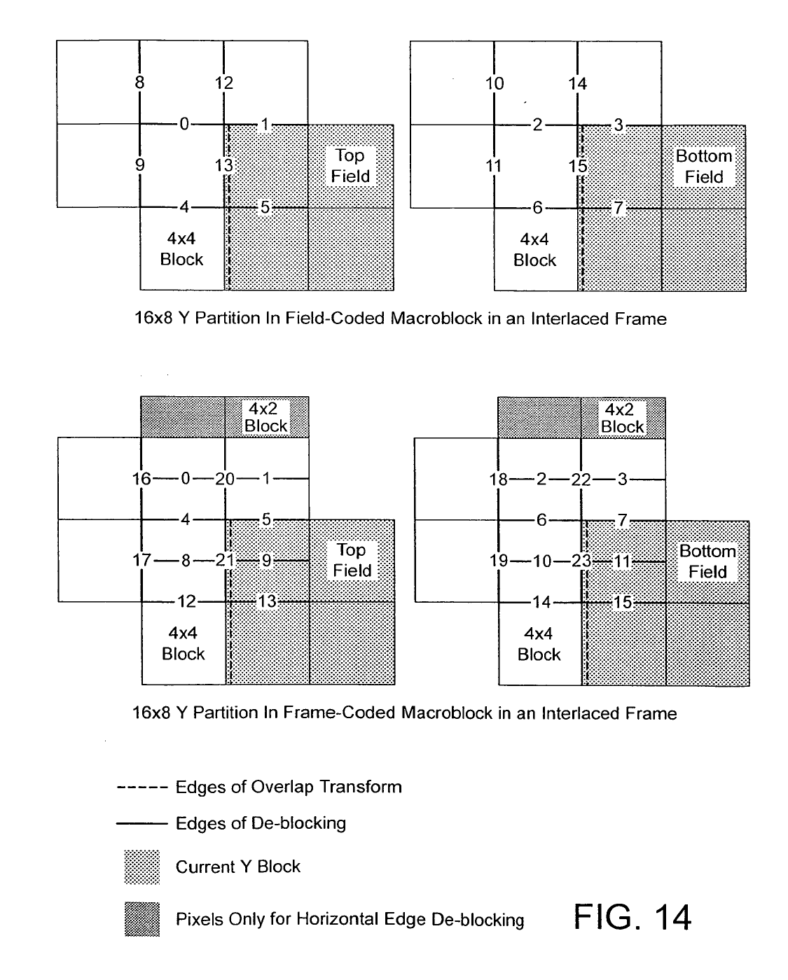

The edge orders for de-blocking of two 16×8 Y partitions in a frame or field coded macroblock in a frame coded interlaced picture are shown in FIG. 14. As VC-1 specifies, the de-blocking in a field coded macroblock may be required only in each of the 4×4 horizontal and vertical edges. But the de-blocking in a frame coded macroblock could be required in each of the 4×4 vertical edges and each of the 4×2 horizontal edges. In addition, horizontal edges should be filtered before vertical edges. Also the edges of the overlap transform are shown in dotted lines in FIG. 14. As top and bottom fields need to be independently filtered, the 16×8 top and bottom field Y partitions are reorganised as two new 16×8 partitions so that the gap between reusing a 4×4 block can be at least 4. As shown in FIG. 14, each of 16×8 partitions contains an 8×8 top field block and an 8×8 bottom field block. From the FIG. 14, 16 4×4 blocks are needed for edge filtering of a 16×8 Y partition in a field coded macroblock and 20 4×4 blocks are need for edge filtering of 16×8 Y partition in a frame coded macroblock. As only 8 rows of Y pixels in the upper macroblocks are needed for the field coded macroblock, comparing with the scheme that need 16 rows of Y pixels in upper macroblocks a 50% bandwidth reduction is obtained for Y pixels. For frame coded macroblock, 12 rows of Y pixels in the upper macroblocks are needed so a 40% bandwidth reduction is obtained.

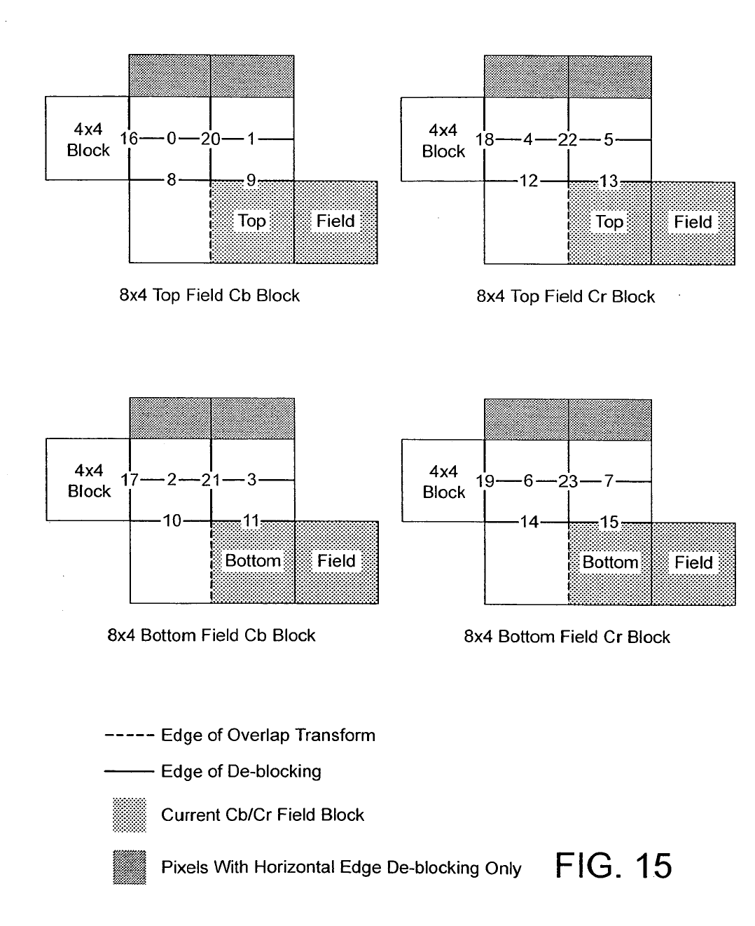

The edge orders of de-blocking for Cb/Cr partitions in a frame or field coded macroblock in a frame coded interlaced picture are shown in FIG. 15. VC-1 specifies that the Cb/Cr de-blocking in a field or frame coded macroblock could be required in each of the 4×4 vertical edges and each of the 4×2 horizontal edges. In addition, horizontal edges should be filtered before vertical edges. Also the edges of overlap transform are shown in dotted lines in FIG. 15. Proper Cb/Cr edge order is arranged so that the gap between reusing a 4×4 block is no less than 4. From the figure, 32 4×4 blocks are needed for edge filtering of Cb/Cr partition in a frame coded interlaced picture.

As the progressive frame edge filtering order is the same as the order for field coded pictures, all orders in the field coded picture can be used in a progressive frame.

Pixel data from the main buffer 1010 is supplied to the local buffer 11010 of FIG. 10 in orders appropriate to whichever of the above implementation is being performed.

It will be appreciated from the above, that overlap transform for a current block is performed before de-blocking is completed for an upper 16×8 partition that crosses upper macroblock and upper left macroblock. The buffers of FIG. 10 are sized to enable this to be handled in an efficient manner.

1. A method for performing overlap transform and de-blocking of a decompressed video signal comprising steps of;
subdividing an image into a plurality of non-overlapping macroblocks each comprising a plurality of smaller sub-blocks;
subdividing each macroblock into two luminance partitions and one chrominance partition;
buffering each partition which is to be overlap transformed, and de-blocked;
buffering sub-blocks of each partition;
performing overlap transform and de-blocking using the line edge filter applied to the edges of the plurality of sub-blocks; and
outputting the filtered data,
wherein the buffering step comprises buffering sub-blocks from a partition for a current macroblock, and sub-blocks for partitions from adjacent upper macroblock, an adjacent upper left macroblock, and an adjacent left macroblock, and the step of overlap transform is performed for edges in the current macroblock and the step of de-blocking is performed for at least some blocks in the adjacent upper, adjacent upper left, and adjacent left macroblocks.

2. A method according to claim 1 in which the overlap transform and deblocking are each performed in parallel for the luminance and chrominance partitions.

3. A method according to claim 1 in which the overlap transform and deblocking are performed sequentially for each of the luminance and chrominance partitions.

4. A method according to claim 1 in which overlap transform is first performed on the leftmost edges of a partition, and subsequently on the uppermost edges of a partition in a current macroblock, using data from adjacent macroblocks

5. A method according to claim 1 in which deblocking is performed for at least part of an adjacent upper macroblock after overlap transform for that macroblock and for part of a current macroblock.

6. A method according to claim 5 in which deblocking is performed for at least part of an adjacent upper left macroblock after overlap transform for that macroblock and for part of a current macroblock.

7. A method according to claim 1 in which the video signal is an interlaced video signal.

8. A method according to claim 7 in which the video signal is frame coded for overlap transform and de-blocking.

9. A method according to claim 1 in which for overlap transform and deblocking the edges of sub-blocks are selected to be processed in an interleaved order such that pixels used to filter an edge will not be used until at least two further edges have been filtered.

10. Apparatus for performing overlap transform and de-blocking of a video picture comprising:
means for subdividing an image into a plurality of macroblocks each comprising a plurality of smaller sub-blocks;
means for subdividing each macroblock into two luminance partitions and one chrominance partitions;
a buffer for storing each partition which is to be overlap transformed and deblocked;
a local buffer for storing sub-blocks of each partition;
an edge filter for line filtering edges between sub-blocks of partitions to perform overlap transform and deblocking; and
an output buffer for providing filtered data to an external frame buffer,
wherein the buffer stores sub-blocks from a current partition and sub-blocks from partitions from adjacent upper, upper left, and left macroblocks and the edge filter performs overlap transform on sub-blocks from the current macroblock and de-blocking on sub-blocks from the adjacent upper, upper left, and adjacent left macroblocks,

11. Apparatus according to claim 10 in which a separate edge filter is provided for each of the partitions wherein the partitions may be processed in parallel for overlap transform and deblocking.

12. Apparatus according to claim 10 in which overlap transform is performed prior to deblocking.

13. Apparatus according to claim 10 in which overlap transform is first performed on the leftmost edges of each partition and subsequently on the uppermost edges of each partition using pixels from adjacent macroblocks upper and upper left.

14. Apparatus according to claim 10 in which deblocking is performed for at least part of an adjacent upper macroblock after overlap transform for part of current macroblock.

15. Apparatus according to claim 14 in which deblocking is performed for at least part of an adjacent upper left macroblock after overlap transform for part of current macroblock.

16. Apparatus according to claim 10 in which the video signal is an interlaced video signal.

17. Apparatus according to claim 16 in which the video signal is frame coded for overlap transform and de-blocking.

18. Apparatus according to claim 10 in which the edge filters edges between sub-blocks for overlap transform and deblocking, in an interleaved under such that pixels used to filter an edge will not be used again until at least two further edges have been filtered.

19. A method for video edge filtering substantially as herein described with reference to the accompanying drawings.

20. Apparatus for video edge filtering substantially as herein described.
